(19) United States
(12) Patent Application Publication
(10) Pub. No.: US 2017/0250998 A1
(43) Pub. Date: Aug. 31, 2017

(54) SYSTEMS AND METHODS OF PREVENTING INFECTION OR DATA LEAKAGE FROM CONTACT WITH A MALICIOUS HOST SYSTEM

(71) Applicant: SnoopWall, Inc., Nashua, NH (US)

(72) Inventors: Gary S. Miliefsky, Nashua, NH (US); Ken Lichtenberger, Nashua, NH (US)

(73) Assignee: SnoopWall, Inc., Nashua, NH (US)

(21) Appl. No.: 15/410,101

(22) Filed: Jan. 19, 2017

Related U.S. Application Data
(60) Provisional application No. 62/301,388, filed on Feb. 29, 2016.

(51) Int. Cl. H04L 29/06; G06F 17/30

(52) U.S. Cl. CPC H04L 63/1416; H04L 63/02; H04L 63/1441; G06F 17/30424

(57) ABSTRACT

Methods and systems are described for the detection of malicious host systems in real time using techniques that are computationally efficient, and that minimize delays or interruptions to the flow of network transmissions. The methods and systems include using a Bloom filter to efficiently determine that a host name requested by a user device is not on a list of known malicious hosts. However, because the Bloom filter may also ambiguously determine that the requested host name may be on the list of host names for which communication is prohibited, an SQL table storing the list of prohibited host names is referenced to resolve any ambiguous determinations of the Bloom filter.

### RELATED APPLICATIONS

This application claims priority under 35 USC §119(e) to U.S. Provisional Patent Application No. 62/301388 entitled “Systems and Methods of Preventing Infection or Data Leakage from Contact with a Malicious Host System,” filed on Feb. 29, 2016, which is incorporated by reference herein in its entirety.

### TECHNICAL FIELD

The present disclosure relates generally to network security. Specifically, the present disclosure relates to detection of malicious host systems and systems and methods to prevent contact therewith.

### BACKGROUND

The protection of networks and their associated devices from malware (e.g., viruses, worms, Trojan horses, botnets, remote access Trojans (RATs), spyware, etc.) is an ongoing technological effort. Malware protection is particularly important for networks that permit connections from mobile devices, which are able to connect to multiple networks throughout a given day, and thus readily transmit malware between networks. Most exploitation occurs because of an end-user clicking a hyperlink or opening an email or related attachment which then initiates an Internet connection session that results in a) data leakage through phishing or spear phishing for confidential information such as usernames, passwords or other confidential credentials and information or b) the installation of malware due to vulnerabilities or end-user error, in which the completion of the Internet session allows for the installation of these new forms of malware, compromising a network behind a firewall.

Conventional anti-phishing and malware protection using malware signatures relies on an initial detection of malware, construction of a signature corresponding to the newly detected malware, and updating malware detection software executed on devices within a network to detect malware with a recognizable signature. While helpful, this conventional malware protection method is time consuming and labor intensive.

### SUMMARY

An example of the present disclosure includes a method that includes monitoring a plurality of transmissions within an internal network; identifying, within a transmission of the plurality of transmissions, a request from a device to communicate with a third party host, the request including an identifier of the third party host; generating a hash value based on the identifier; determining whether the hash value is stored within a Bloom filter generated from hash values of identifiers of malicious hosts; responsive to determining that the hash value is stored within the Bloom filter, determining whether the identifier is stored within a list of the identifiers of the malicious hosts; and responsive to determining that the identifier is stored within the list, disrupting subsequent transmissions between the device and the third party host. In an embodiment, disrupting the subsequent transmissions includes disrupting subsequent transmissions from a process being executed by the device without disrupting other operations of the device. In an embodiment, disrupting the subsequent transmissions includes disrupting connectivity between the device and the internal network. In an embodiment, disrupting the subsequent transmissions includes disrupting connectivity between the device and the internal network. In an embodiment, the example further includes permitting the subsequent transmissions in response either to determining that the identifier is not stored in the list or to determining that the hash value is not stored within the Bloom filter. In an embodiment, the example further includes receiving the list; generating the hash values of the identifiers of the malicious hosts from the list; and storing the hash values of the identifiers of the malicious hosts in the Bloom filter. In an embodiment, the example further includes receiving an updated list; identifying one or more identifiers in the list that are not included in the updated list; and removing, from the Bloom filter, hash values generated from the one or more identifiers not included in the updated list. In an embodiment, monitoring the plurality of transmissions includes monitoring the plurality of transmissions via a network security device that is a peer to the device. In an embodiment, monitoring the plurality of transmissions includes monitoring the plurality of transmissions via either a firewall or a switch. In an embodiment, identifying the request includes identifying a request that includes at least one of a host name and a transmission control protocol/Internet protocol address. In an embodiment, determining whether the identifier is stored within the list includes searching a structured query language table. In an embodiment, monitoring the plurality of transmissions includes monitoring a plurality of transmissions within an internal network disposed behind a firewall.

An example of the present disclosure includes a network monitoring system including memory, a network interface; and at least one processor coupled to the memory and the network interface and configured to: monitor a plurality of transmissions within an internal network via the network interface; identify, within a transmission of the plurality of transmissions, a request from a device to communicate with a third party host, the request including an identifier of the third party host; generate a hash value based on the identifier; determine whether the hash value is stored within a Bloom filter generated from hash values of identifiers of malicious hosts; responsive to the determination that the hash value is stored within the Bloom filter, determine whether the identifier is stored within a list of the identifiers of the malicious hosts; and responsive to the determination that the identifier is stored within the list, disrupt subsequent transmissions between the device and the third party host; and a pre-cognition detection engine in communication with the at least one processor, the pre-cognition detection engine comprising a Bloom Filter and an SQL table, wherein at least one of the Bloom Filter and the SQL table is used to determine whether a requested third party host name is associated with a known malicious host. In an embodiment, the example further includes a web server. In an embodiment, the processor is further configured to disrupt subsequent transmissions from a process being executed by the device without disrupting other operations of the device. In an embodiment, the processor is further configured to disrupt connectivity between the device and the internal network. In an embodiment, the processor is further configured to permit the subsequent transmissions in response either to determining that the identifier is not stored in the list or to determining that the hash value is not stored within the Bloom filter. In an embodiment, the processor is further configured to: receive the list; generate the hash values of the identifiers of the malicious hosts from the list; and cause the hash values of the identifiers of the malicious hosts to be stored in the Bloom filter. In an embodiment, the network monitor system is a peer to the device. In an embodiment, the example further includes at least one of a firewall and a switch in communication with the network monitor system. In an embodiment, the processor is configured to monitor a plurality of transmissions within an internal network disposed behind a firewall.

### BRIEF DESCRIPTION OF THE DRAWINGS

FIG. 1A illustrates a system environment that includes systems for detecting malicious host systems, in an embodiment.

FIG. 1B illustrates a network monitor used in the system environment of FIG. 1A, which detects requests to communication with hosts known to be malicious by using some or all of a Bloom filter, and a structured query language (SQL) table, in an embodiment.

FIG. 1C is a block diagram representing an example computing device 1000 that may be used to perform any of the techniques as variously described in this disclosure.

FIG. 2 is a method flow diagram illustrating communications between and operations of various elements of the system environment illustrated in FIG. 1A, in an embodiment.

FIG. 3 is a method flow diagram illustrating a method for determining a malicious network connection using one or both of a Bloom filter and an SQL Table storing host names, in an embodiment.

FIGS. 4A to 4C illustrate various example user interfaces associated with operations of systems for detecting malicious host systems, in an embodiment.

The figures depict various embodiments of the present disclosure for purposes of illustration only. Numerous variations, configurations, and other embodiments will be apparent from the following detailed discussion.

### DETAILED DESCRIPTION

### Overview

Embodiments of the present disclosure include methods and systems for the detection of malicious host systems in real time, or substantially real time, using techniques that are computationally efficient, and that minimize delays or interruptions to the flow of transmissions between user devices of an internal network system and third party hosts via an external network, such as the Internet. The benefits associated with embodiments of the present disclosure (e.g., computational efficiency and minimization of delays of network transmissions) are achieved by using a network monitor (also referred to herein as a “network security device” or a “network monitor system” in some embodiments) to examine internal network transmissions between a user device and, for example, a firewall server or other server. The network monitor stores, in two different forms, a list of host names known to be malicious and with which communication is prohibited. In the first form, the host name list is hashed and stored in a file for use by a Bloom filter. The Bloom filter, using the hashed host name list file, is able to efficiently determine that a host name requested by a user device is not on the list. However, because the Bloom filter may also ambiguously determine that the requested host name may be on the list of host names for which communication is prohibited, an SQL table storing the list of prohibited host names is also stored within the internal network. This SQL table can be referenced to resolve any ambiguous determinations of the Bloom filter. Thus a definitive determination can be made in a computationally efficient way that causes minimal delays to network transmissions. Should a network transmission involve a prohibited host name, any of several methods of denying connectivity between the internal network and the user device may be implemented, thereby preventing the user device from completing any interactions with the prohibited host and from affecting other devices on the internal network.

### System Environment

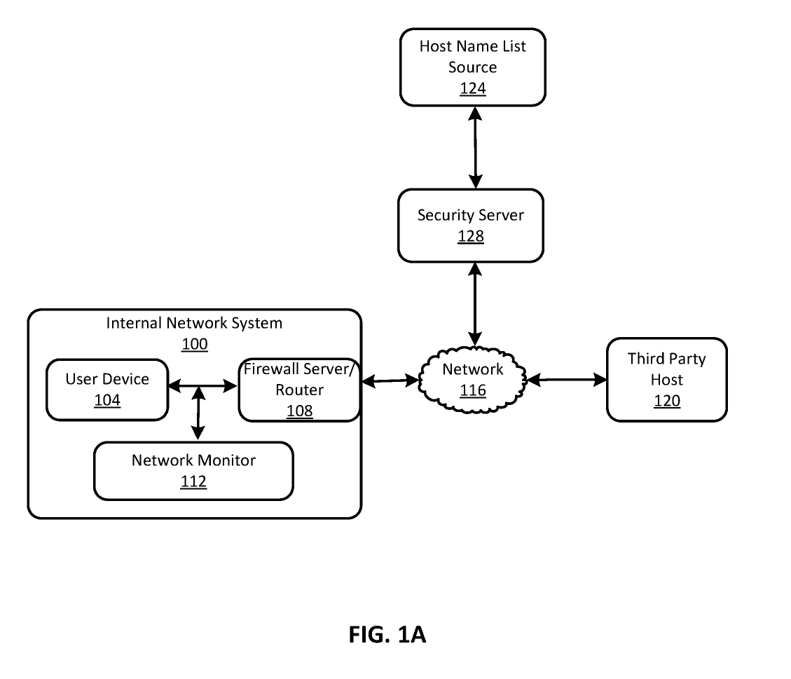

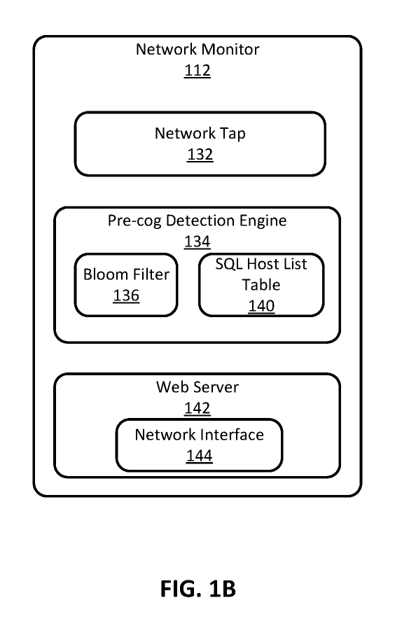

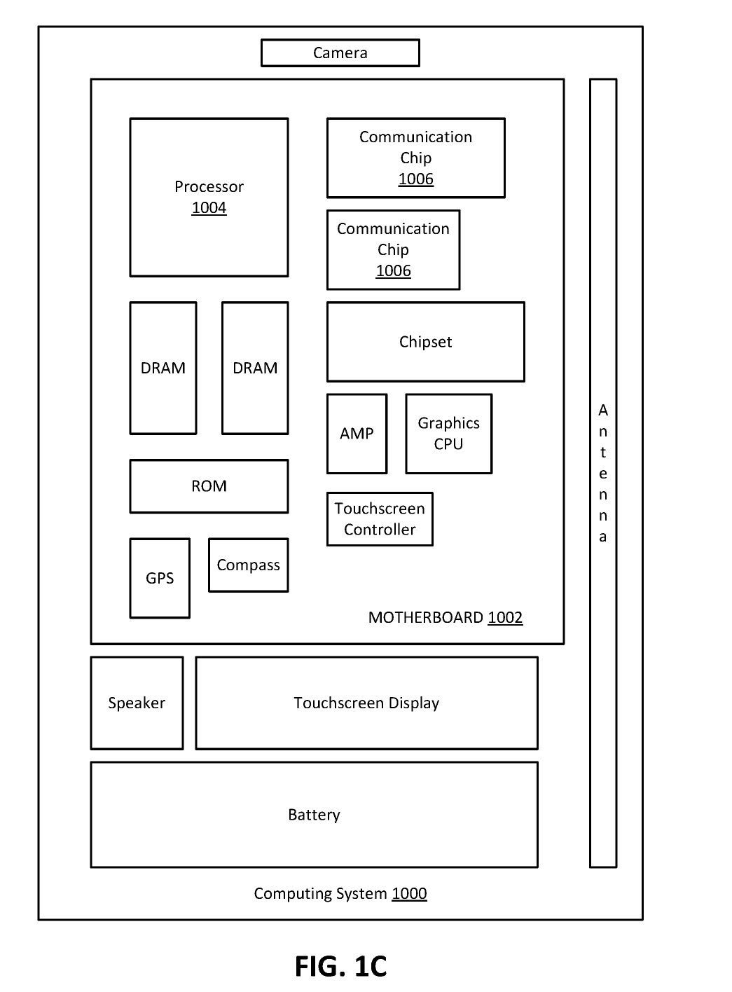

FIG. 1A illustrates a system environment that includes systems for detecting malicious host systems, in an embodiment. The system environment includes an internal network system 100, a network 116, a third party host 120, a host name list source 124, and a security server 128.

As indicated above, the internal network system 100 includes user devices, network connections, and network infrastructure used to establish electronic communication (e.g., through transmissions of packets in a packet network) between user devices, servers, and other equipment within a network. For example, the internal network system 100 may include routers, wireless transponders, network load balancers, authentication servers, storage area networks, but these devices are omitted from FIG. 1A for clarity of explanation. As shown in FIG. 1A, the internal network system 100 includes a private network associated with an entity or individual, as distinct from the Internet. For example, the internal network system 100 may include systems used to maintain a private corporate network, an access restricted network associated with a government agency, or an access restricted network associated with educational institution or an individual.

The internal network system 100 of FIG. 1A is depicted as including a user device 104, a firewall server 108, and a network monitor 112.

The user device 104 is a computing device capable of receiving user input as well as transmitting and/or receiving data within the internal network system 100 and, ultimately, with the network 116. In one embodiment, the user device 104 is a conventional computer system, such as a desktop or laptop computer. In another embodiment, the user device 104 may be a device having computer functionality, such as a personal digital assistant (PDA), mobile telephone, tablet computer, smartphone or similar mobile computing device that, in some embodiments, includes an application programming interface (API) that runs on the native operating system of the user device 104, such as IOS® or ANDROID™.

The firewall server 108 of the internal network system 100 is a computing device configured to execute instructions for evaluating whether transmissions to and from the internal network system 100 are authorized. For example, the firewall server 108 may store instructions (referred to generally as “security policies”) that execute malware detection signatures, authentication processes, and other processes for detecting and/or preventing unauthorized transmissions from entering or leaving the internal network system 100. Because traffic to and from the internal network system 100 is routed through the firewall server 108, any traffic that does not meet the requirements of authorized traffic (e.g., because it contains a malware signature known to the firewall server 108 or fails an authentication) can be detected and prevented from either entering or leaving the internal network system 100. However, because transmissions are to and from the internal network system 100 are actively evaluated by the firewall server 108 for compliance with security policies, the firewall server 108, when applying conventional malware detection and prevention methodologies, can cause delays in the speed with which transmissions are exchanged between the internal network system 100 and the network 116.

The network monitor 112 of the internal network system is shown in the embodiment of FIG. 1A as monitoring transmissions between the user device 104 and the firewall 108. As will be described below in more detail, the network monitor 112 includes elements that evaluate whether transmissions from, for example, the user device 104 are requesting communication with a host that is known to be malicious. Responsive to the determination that the transmission is requesting communication with a known malicious host, the network monitor 112 can prevent the transmission from affecting the internal network system 100 by, for example, preventing the user device 104 from completing communication (referred to herein as “disrupting communications”) with the host and from communicating with other devices on the internal network system 100. Even in the event that this first transmission is completed between the user device 104 and a known malicious host, subsequent transmissions between the user device 104 and the known malicious host can be disrupted by the network monitor 112. It is appreciated that, in some examples, the firewall 108 may be a router server or some other network forwarding device that may or may not provide protection to the internal network system 100.

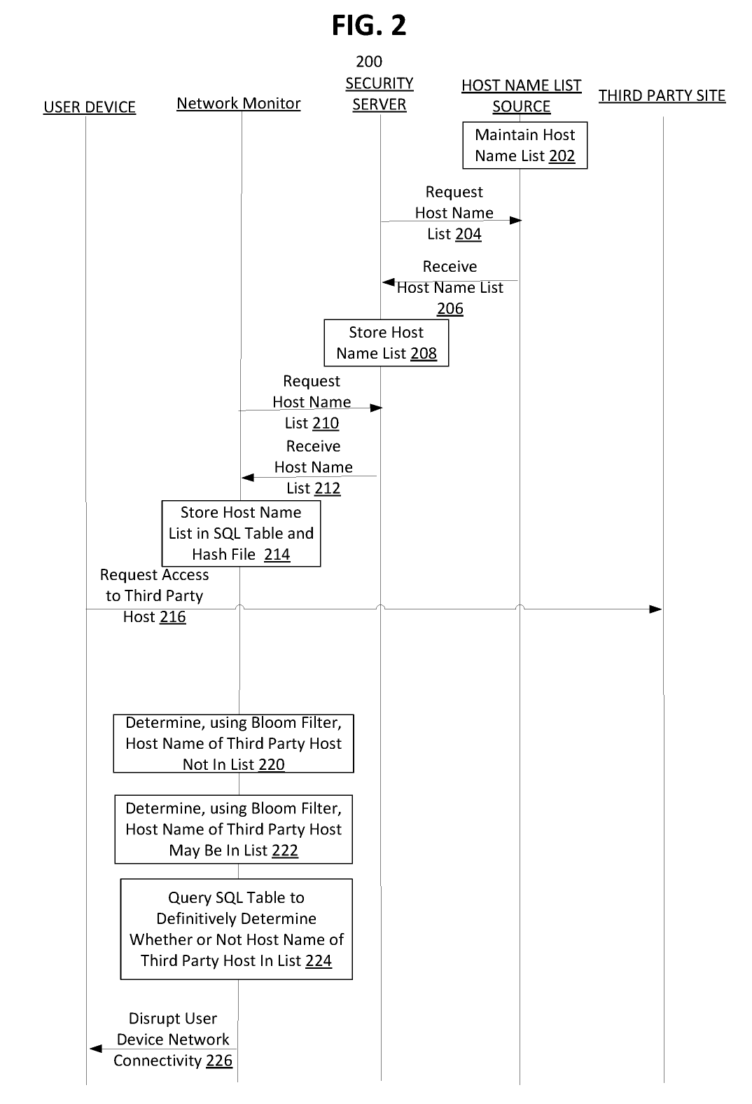

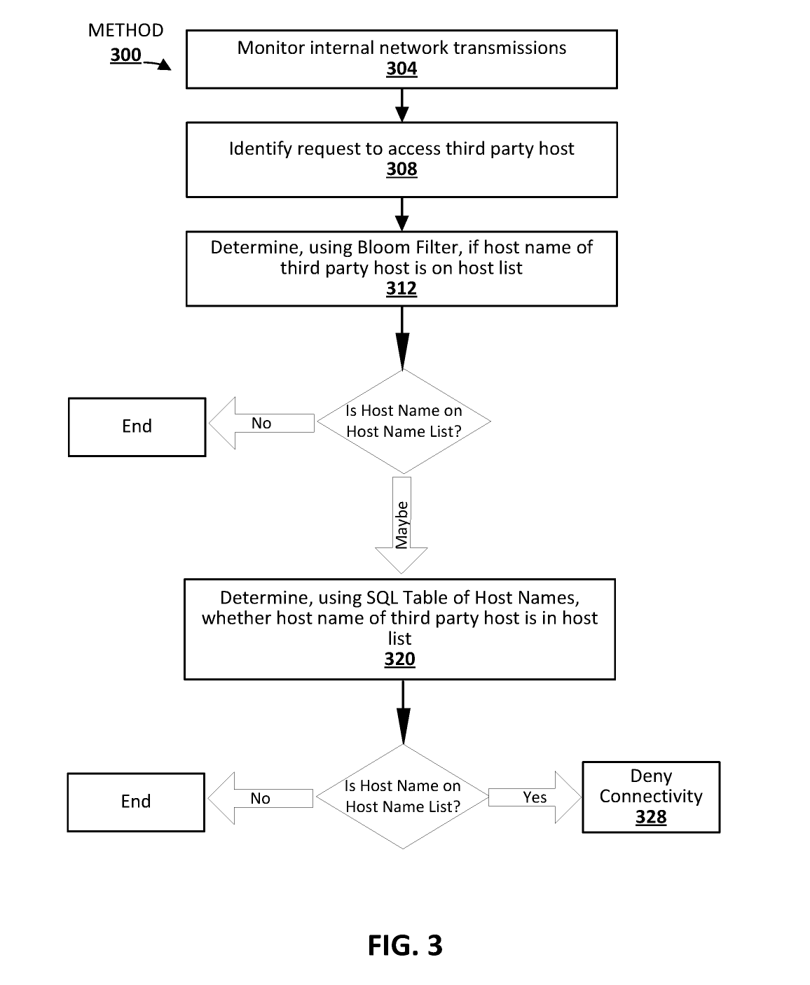

The network monitor 112 can include mechanisms for passively monitoring transmissions within the internal network system 100. By passively monitoring these transmissions, the flow of transmissions within the internal network system 100 is not substantially inhibited or delayed even though the transmissions are analyzed for requests to communicate with a host known to be malicious. Details of example monitoring methods implemented by the network monitor 112 will be discussed below in more detail in the context of FIGS. 2 and 3. Examples of network monitors 112 that can be adapted to apply the example methods of FIGS. 2 and 3 include “packet sniffers” or “packet analyzers.”

It will be understood that the network monitor 112 may be placed at locations within an internal network system other than the one shown in FIG. 1A that, even though not shown, are known to those skilled in the art as being convenient locations within an internal network to monitor network transmissions. It will also be understood that the network monitor 112 (alternatively referred to as a “network security device”) may be configured as a peer device to the user device 104 of the internal network system 100. As used herein, “peer device” refers to devices that have a same level of authority within the internal network system 100. In examples in which the network monitor 112 is configured as a peer device the user device 104, the network monitor 112 has authority associated with that of a typical user device but not authority associated with, for example, the firewall or a network security administrator, for example. In another characterization of the phrase “peer device,” the network security monitor 112 is an endpoint for network communications and is not considered a network infrastructure device, such as a load balancer, firewall server, authentication server, and other devices that are not typically endpoint (i.e., addressees of packets) for network traffic. For these reasons, peer devices generally do not have the ability and/or authorization to filter packets addressed to other devices within the internal network system.

The network 116 may comprise any combination of local area and/or wide area networks, using both wired and wireless communication systems. In one embodiment, the network 116 uses standard communications technologies and/or protocols. Thus, the network 116 may include links using technologies such as Ethernet, 802.11, worldwide interoperability for microwave access (WiMAX), 3G, 4G, CDMA, digital subscriber line (DSL), and combinations thereof. Similarly, the networking protocols used on the network 116 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 116 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

Third party host 120 is any server associated with a host name, user resource link (URL), IP address, or other specific network address with which the user device 104 requests communication. In one example, the third party host 120 serves webpages, executable content, or other similar content. In another example, the third party host 120 is an exchange server through which other electronic communications (e.g., email, text messages, and images) are transmitted between users. Regardless of the types of information transmitted through the third party host 120, it is provided in the present disclosure as an example of a device connected to the network 116 and with which the user device 104 has requested communication.

The host name list source 124 is a publisher or provider of host names known to be malicious. The malicious hosts may be known to execute “drive by” installations of malware and/or be known to phish for sensitive user information (e.g., logon credentials, financial account information, personal identifiers (e.g., social security numbers), etc.) One example of a host name list source 124 is provided by the Anti-Phishing Working Group (APWG). The APWG identifies, or receives identifications of, host names, IP addresses, URLs, and other specific network 116 identifiers or addresses associated with hosts known to be malicious. The APWG then provides a consolidated list of these identified malicious hosts so that operators and administrators of private networks (such as internal network system 100) may protect their corresponding internal network systems 100 against these known threats to network security.

The security server 128 is a server that receives the host name list in its entirety, and/or receives updates to the host name list, that is provided by or available from the host name list source 124. The security server 128 then provides the host name list and/or updates to the host name list to the network monitor 112, as will be described below in more detail.

While the security server 128 is shown external to the internal network system 100 in the embodiment of FIG. 1A, it will be understood that alternative embodiments may have the security server 128 disposed within the internal network system 100 or in direct communication with the internal network system 100.

FIG. 1B illustrates an embodiment of the network monitor 112 used in the internal network system 100 of FIG. 1A. As described above, the network monitor 112 is used to detect malicious host systems using some or all of a network tap 132 and a Pre-cognition Detection Engine 134 that uses a Bloom filter 136 and an SQL host list table 140 so as to minimize delays to transmissions to, from, and within the internal network system 100 in a computationally efficient manner.

The network tap 132 (otherwise known as a traffic access point or “TAP”) passively monitors transmissions traveling between two points within a network. This passive monitoring allows the transmissions to travel unimpeded from a source to a destination while also permitting evaluation of the transmissions for compliance with security policies. In examples of networks that use optical transmissions, the network tap passively monitors transmissions by diverting a portion of the optical signal intensity, thus copying the transmission for later evaluation for compliance with the security policies. Other types of networks will use taps that copy the transmissions in a way appropriate to the signal that also does not inhibit or slow transmission flow through the internal network system 100.

Regardless of the passive monitoring technology used, once a transmission is provided, the network monitor 112 applies methods, such as the example methods described below in the context of FIGS. 2 and 3, to determine whether the user device 104 is requesting communication with a host known to be malicious. These example methods that are described below may be executed by the Pre-cognition (“Pre-cog”) Detection Engine 134 and may use a Bloom filter 136 and/or an SQL host list table 140 to determine whether or not the transmission is requesting communication with a host known to be malicious.

The Bloom filter 136 is a data structure that efficiently and quickly determines whether an element is a member of a set. While false positive results are possible, false negative results are not. Thus, applying a Bloom filter 136 to network transmissions and the list of known malicious hosts can either (a) definitively determine that the requested host name is not on the list of known malicious host names or (b) determine that the requested host name may be on the list of known malicious host names. Both of these cases are discussed below in more detail in the context of FIG. 2.

Another feature of the Bloom filter is that the time required to determine whether an element is a member of set is largely independent from the size of the set, so that even extremely large data sets (such as lists of host names known to be malicious) are examined quickly, and thus minimize delays in transmissions to and from the internal network system 100. While not shown, the Bloom filter 136 includes, or is in communication with, a stored representation of the list of host names or IP addresses (also referred to as “host identifiers”) known to be malicious, such as a file of hash values generated from the list (“hash file” for brevity). Using a hash file further improves the speed and efficiency with which host names known to be malicious are identified, or possibly identified, by the Bloom filter 136.

The Pre-cognition Detection Engine 134 also includes an SQL host list table 140. As will be explained below in more detail in the context of FIGS. 2 and 3, because the Bloom filter 136 may provide a false positive result (case (b) mentioned above), the SQL host list table is used to definitively determine whether or not a host identifier is on the list of identifiers of hosts know to be malicious for situations in which the Bloom Filter 136 is unable to make this definitive determination. The SQL host list table 140 allows the network monitor 112 to specifically search for a match between the queried host name and the host names stored in the SQL host list table 140. Thus, any ambiguous results (i.e., false positive results indicated as not definitive) provided by the Bloom filter 136 are resolved quickly and efficiently.

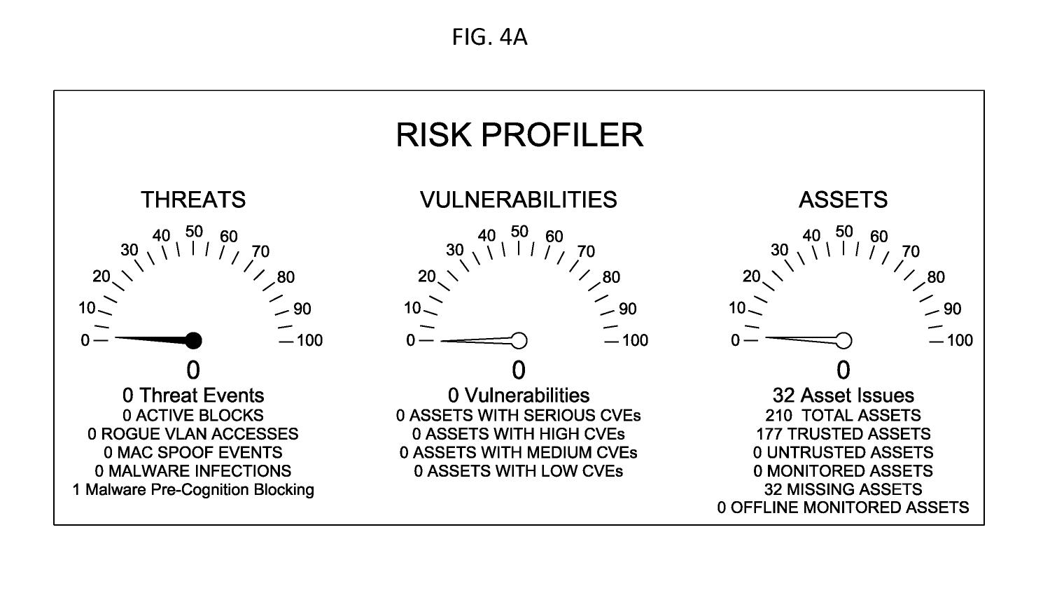

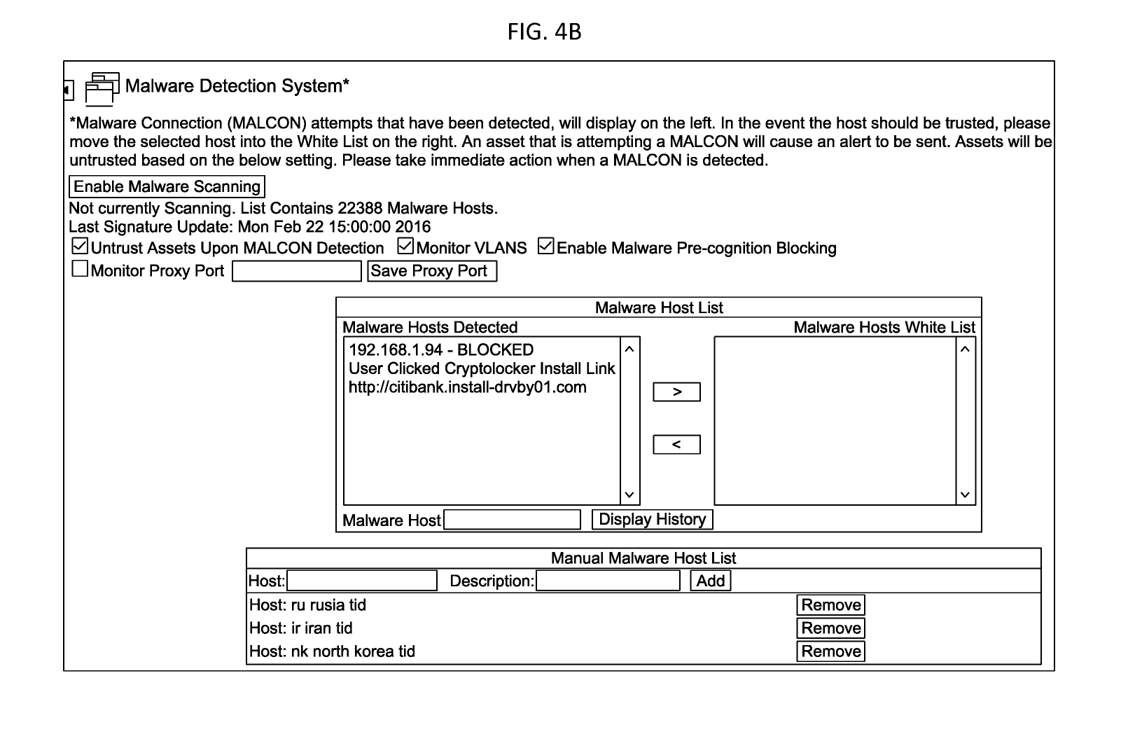

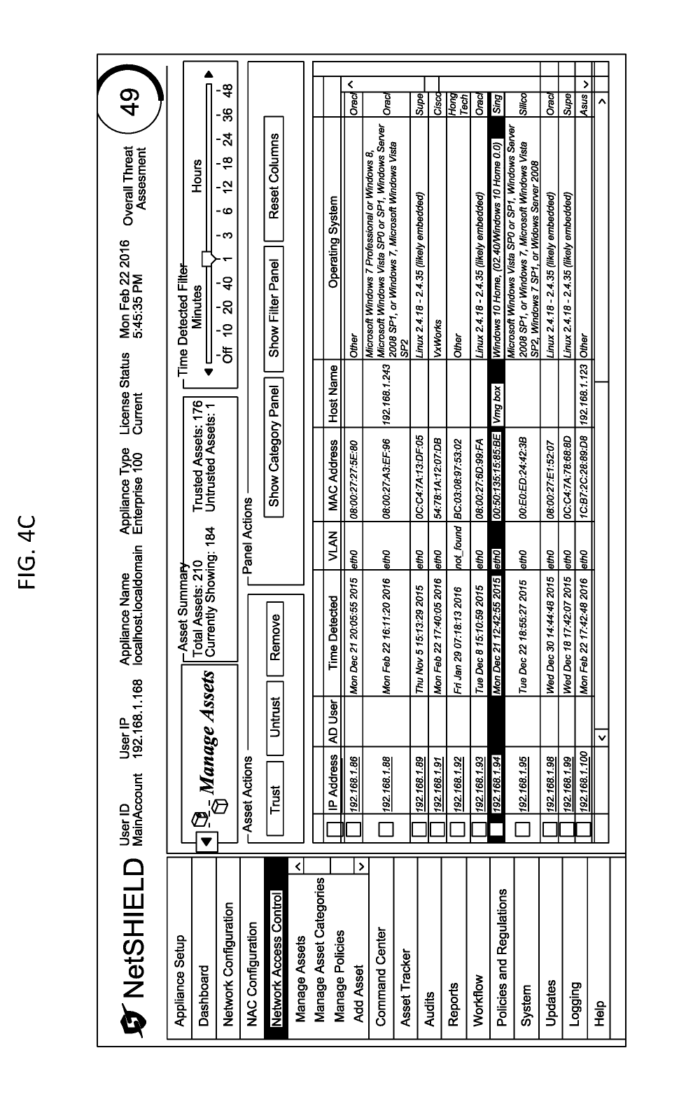

In at least one example, the network monitor 112 includes a web server 142 configured to serve webpages that include content descriptive of the activities of the network monitor. The web server 142 can accomplish this by, for example, serving webpages and executing instructions associated with the webpages, such as may be defined by JAVA® code, FLASH® code, and XML. The web server 142 may also provide application programming interface (API) functionality to send data directly to native client device operating systems, such as IOS®, ANDROID™, WEBOS® or RIM. Some examples of webpages served by the web server 142 are described further below with reference to FIGS. 4A-4C. In some examples, the web server 142 may include a network interface 144 that facilitates communication between the network monitor 112 and other devices within the internal network system 100 and the network 116. Examples of the network interface 144 include physical network interface components (e.g., an RJ-45 or other hardware port) and a software stack (e.g., include one or more drivers) that support operation of the physical network interface components.

In addition to the network tap 132 or equivalent device used to copy or otherwise passively monitor network transmissions, the network monitor 112 may include, or be in communication with, processors and transitory and/or non-transitory computer readable media used to store and execute instructions, and store data (e.g., hashes of host name lists, SQL tables, copies of network transmissions) useful for enabling embodiments described herein.

FIG. 1C is a block diagram representing an example computing device 1000 that may be used to perform any of the techniques as variously described in this disclosure. For example, the user device 104, the various network components, servers, or any combination of these may be implemented in the computing device 1000. The computing device 1000 may be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described in this disclosure. A distributed computational system may be provided comprising a plurality of such computing devices.

The computing device 1000 includes one or more storage devices 1010 and/or non-transitory computer-readable media 1020 having encoded thereon one or more computer-executable instructions or software for implementing techniques as variously described in this disclosure. The storage devices 1010 may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught in this disclosure. The storage device 1010 may include other types of memory as well, or combinations thereof. The storage device 1010 may be provided on the computing device 1000 or provided separately or remotely from the computing device 1000. The non-transitory computer-readable media 1020 may include, but are not limited to, one or more types of hardware memory, non-transitory tangible media (for example, one or more magnetic storage disks, one or more optical disks, one or more USB flash drives), and the like. The non-transitory computer-readable media 1020 included in the computing device 1000 may store computer-readable and computer-executable instructions or software for implementing various embodiments. The computer-readable media 1020 may be provided on the computing device 1000 or provided separately or remotely from the computing device 1000.

The computing device 1000 also includes at least one processor 1030 for executing computer-readable and computer-executable instructions or software stored in the storage device 1010 and/or non-transitory computer-readable media 1020 and other programs for controlling system hardware. Virtualization may be employed in the computing device 1000 so that infrastructure and resources in the computing device 1000 may be shared dynamically. For example, a virtual machine may be provided to handle a process running on multiple processors so that the process appears to be using only one computing resource rather than multiple computing resources. Multiple virtual machines may also be used with one processor.

A user may interact with the computing device 1000 through an output device 1040, such as a screen or monitor, which may display one or more user interfaces provided in accordance with some embodiments. The output device 1040 may also display other aspects, elements and/or information or data associated with some embodiments. The computing device 1000 may include other I/O devices 1050 for receiving input from a user, for example, a keyboard, a joystick, a game controller, a pointing device (e.g., a mouse, a user's finger interfacing directly with a display device, etc.), or any suitable user interface. The computing device 1000 may include other suitable conventional I/O peripherals, such as a camera 1052. The computing device 1000 can include and/or be operatively coupled to various suitable devices for performing one or more of the functions as variously described in this disclosure.

The computing device 1000 may run any operating system, such as any of the versions of Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 1000 and performing the operations described in this disclosure. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described in this disclosure. In a more general sense, any suitable combination of hardware, software, and firmware can be used, as will be apparent.

As will be appreciated in light of this disclosure, the various modules and components of the system shown in FIGS. 1A and 1B, can be implemented in software, such as a set of instructions (e.g., HTML, XML, C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided in this disclosure to be carried out. It will be appreciated that, in some embodiments, various functions performed by the user computing system, as described in this disclosure, can be performed by similar processors and/or databases in different configurations and arrangements, and that the depicted embodiments are not intended to be limiting. Various components of this example embodiment, including the computing device 1000, can be integrated into, for example, one or more desktop or laptop computers, workstations, tablets, smart phones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent.

FIG. 2 is a method flow diagram of a method 200 illustrating example communications between, and operations of, various elements of the system environment illustrated in FIG. 1A, in an embodiment. In this method 200, the host name list source 124 maintains 202 a list of host names known to be malicious. As described above, one example of such a host name list source 124 is APWG. Other sources, freely accessible, accessible upon subscription, and/or otherwise maintained with restricted access may also be used as an equivalent or supplement to the APWG host name list. Regardless of the identity of the host name source itself, the host name list is periodically published and/or updates to the list of known malicious host names are published.

In the embodiment shown, the security server 128 requests 204 the host name list or requests updates to a host name list version previously requested and locally stored at the security server 128. This request can be made by the security server 128 to the host name list source 124 regularly (for example, every hour) so that updates to the list of malicious hosts stored by the security server 128 and/or stored within the network monitor 112 remain current. Furthermore, the security server 128 may test whether the hosts identified in the list are still active by regularly testing (e.g., every minute, every hour, and/or every day) connectivity between the identified hosts and the network 116 by, for example, an http ping. In some examples, those hosts that are listed in the host name list stored by the security server 128 that do not respond to the http ping are removed from the list stored at the security server 128, thus improving computational efficiency the embodiments described herein.

The current list of malicious hosts thus being stored at the security server 128, the Pre-cognition Detection Engine 134 periodically (e.g., every hour to three hours) requests the updated list from the security server 128. The updated list is then received by the Pre-cognition Detection Engine 134 from the security server 128. Upon receiving 206 the host name list and/or an update to the list, the list is used to generate hash values of identifiers of malicious hosts that are stored 208 in a hash file for use by the Bloom filter 136. The updated list is also stored 208 in the SQL host list table 140, as described above. The hash file and the SQL host list table can be stored 214 either in memory in the network monitor 112 itself or stored 214 in memory in communication with the network monitor 112 upon the network monitor requesting 210 and receiving 212 the host name list and/or updates to the list. Differences between a current list (i.e., a list currently stored at the security server 128) and an updated list can be identified. Identifying these differences include identifying host identifiers present in the current list but not on the updated list and identifying host identifiers not present in the current list but present on the updated list. Once identified, these differences are then used to maintain a current list of malicious hosts stored at the security server 128.

Upon a request 216 from the user device 104 within the internal network system 100 to access the third party host 120, the Pre-cognition Detection Engine 134 determines 222 whether the requested host name of the third party host 120 may be on the list using the Bloom filter 136. As indicated above, this is a computationally efficient and quick method for determining whether the host name of the third party host 120 is not on the list of known malicious hosts. As also indicated above, the Bloom filter 136 either (a) definitively determines that the requested host name is not on the list of known malicious host names or (b) determines that the requested host name may be on the list of known malicious host names. For the situation in (a), access to the third party host 120 is granted in that the network monitor takes no further action. For the situation in (b), because the determination by the Bloomer Filter 136 is not definitive, a definitive determination 224 is made by querying the SQL table of host names stored locally within the internal network system 100.

Access and any resulting interaction is either allowed or network connectivity for the user device 104 is denied prior to completion of any resulting interaction depending on whether the host name is not on the list or on the list, respectively. In denying or disrupting 226 network connectivity to the user device 104, the Pre-cognition Detection Engine 134 may perform any of a variety of actions that disrupt network communications involving the user device 104. For example, the Pre-cognition Detection Engine 134 may identify the MAC address of the user device and execute a lightweight denial of service attack on the user device 104. This lightweight denial of service attack may manipulate network traffic using techniques such as ARP poisoning, TCP resting, UDP flooding to prevent the user device 104 from communicating with other devices in the internal network system 100. In another example, the Pre-cognition Detection Engine 134 denies network connectivity to the user device 104 by instructing other devices in the internal network system 100 (or a subnet or VLAN thereof) to ignore the user device 104 via, for example, ARP table manipulation. In still another example, the Pre-cognition Detection Engine 134 denies network connectivity to the user device 104 by identifying a physical port (e.g., in a switch, router, hub, or other network forwarding device) or a logical port (e.g., in a VLAN) through which the user device 104 transmits information to the internal network system 100 and deactivating the physical or logical port. In yet another example, the Pre-cognition Detection Engine 134 denies network connectivity to the user device 104 by moving the user device 104 to a quarantined VLAN. In other examples, the Pre-cognition Detection Engine 134 denies network connectivity to the user device 104 by dropping packets addressed to or from the MAC address of the user device 104. In another example, the Pre-cognition Detection Engine 134 denies network connectivity to the user device 104 by transmitting an instruction to the firewall server/router 108 (or a network switch) to block outbound and/or inbound traffic involving the user device 104. In some examples, the Pre-cognition detection engine 134 can identify a malicious process being executed and disrupt the malicious process itself or disrupt communications that are being instructed to be sent by the malicious process. This is advantageous in that other, non-malicious processes executed by the user device 104 are not disrupted during this process, thus enabling legitimate uses performed on the user device 104 to continue while still preventing the malicious process from communicating/executing.

FIG. 3 is a method flow diagram illustrating an example method 300 for determining a malicious network connection using one or both of a Bloom filter 136 and an SQL table of host names 140 that may be executed by the Pre-cognition Detection Engine 134, in an embodiment. The method 300 begins by monitoring 304 (e.g., by the Pre-cognition Detection Engine 134) network transmissions internal to the internal network system 100 and identifying in the internal transmissions whether access to a third party host is requested 308. Once a request to access a third party host has been identified308, the Bloom filter 136 is applied using, as described above, a locally stored (e.g., in memory) hash file of the host name list received from the host name list source to determine 312 whether or not the requested third party host name is not on the list of known malicious hosts. If the Bloom filter definitively determines 312 that the requested third party host name is not on the list of known malicious hosts, then access is granted in that the network monitor 112 takes no further action. If the Bloom filter is not able to definitively determine that the requested third party host name is not on the list of known malicious hosts (in other words, determines that the requested host name may be on the host name list), then a definitive determination 320 is made with reference to the SQL table of host names that, in the embodiment shown in FIG. 1B, is stored in the network monitor 112. If the host name is not in the SQL table of host names that are known to be malicious, then access is granted in that the network monitor 112 takes no further action. If the host name is in the SQL table of host names that are known to be malicious, then network connectivity to the device transmitting the request is denied 328. Such denial may be implemented using any of the denial and/or disruption techniques described above or other techniques.

Thus, in accordance with at least some examples of the present disclosure, a network monitor determines an identifier (e.g., an IP address) of a user device on an internal network that has requested access to and an interaction with a resource external to the internal network. The external resource may be connected to the Internet and may be identified by an IP address. In these examples, the network monitor detects the requested interaction and prevents completion of the interaction by executing any of a variety of techniques that disrupt the interaction, such as those described above that deny network connectivity to the user device. Further, in these examples, the network monitor uses a Bloom filter to execute with speed sufficient to prevent completion of the interaction (e.g., seconds faster than the requested interaction can complete a circuit to and from the requested resource). In this way, the user device is safely quarantined, and the user of the user device can be educated and/or remediated.

FIGS. 4A, 4B, and 4C illustrate various example user interfaces associated with operations of systems for detecting malicious host systems, in various embodiments. FIG. 4A illustrates an administrator dashboard of an internal network system 100 that includes the network monitor 112 executing example methods 200 and/or 300. In a “Threats” graphic indicator, the number of threats detected by the network monitor 112, the types of threats, and the number of times that the network monitor 112 has prevented contact with a known malicious host (indicated as “pre-cognition blocking”) are shown. In a “Vulnerability” graphic indicator, an evaluation of the security of devices within the internal network system 100 is shown, with the number of devices having common vulnerability and exposure (CVE) risks identified. In an “Assets” graphic indicator, the number of devices of the internal network system 100, the activity status of devices, and the security status of devices are also quantified and shown.

FIG. 4B is an example user interface that indicates a detection of a host that is known to be malicious. As indicated in this user interface, the IP address of the host has been identified by either one of the Bloom filter 136 or the SQL table of host names 140 to be a known malicious host. The cause of the request of communication with the known malicious server is also identified (“User clicked Cryptolocker install link . . . ”), which can be used by an administrator to identify deficiencies in other security policies used to protect the internal network system 100 from malware infection.

FIG. 4C is another example user interface depicting all communications with hosts (identified by IP address), the time that the communication was detected, and details regarding the nature of the connection (VLAN, MAC address, Host Name, Operation System, etc.). As shown, a blocked connection with a known malicious host is highlighted for convenient identification by a network administrator.

### Further Considerations

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

Some portions of this description describe the embodiments in terms of processes and symbolic representations of operations on information. These descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. For instance, although the examples disclosed herein focus on the use of a Bloom filter as a rapid lookup mechanism, other examples may use other rapid lookup mechanisms in lieu of the Bloom filter. Examples of such rapid lookup mechanisms include mechanisms based on hash compaction, space efficient variants of cuckoo hashing, other hash functions/lookup techniques and corresponding in-memory data structures. Accordingly, the disclosure of the embodiments is intended to be illustrative, but not limiting, of the scope of the invention, which is set forth in the following claims.

What is claimed is:

1. A method comprising:
monitoring a plurality of transmissions within an internal network;
identifying, within a transmission of the plurality of transmissions, a request from a device to communicate with a third party host, the request including an identifier of the third party host;
generating a hash value based on the identifier;
determining whether the hash value is stored within a Bloom filter generated from hash values of identifiers of malicious hosts;
responsive to determining that the hash value is stored within the Bloom filter, determining whether the identifier is stored within a list of the identifiers of the malicious hosts; and
responsive to determining that the identifier is stored within the list, disrupting subsequent transmissions between the device and the third party host.

2. The method of claim 1, wherein disrupting the subsequent transmissions includes disrupting subsequent transmissions from a process being executed by the device without disrupting other operations of the device.

3. The method of claim 1, wherein disrupting the subsequent transmissions includes disrupting connectivity between the device and the internal network.

4. The method of claim 1, further comprising permitting the subsequent transmissions in response either to determining that the identifier is not stored in the list or to determining that the hash value is not stored within the Bloom filter.

5. The method of claim 1, further comprising:
receiving the list;
generating the hash values of the identifiers of the malicious hosts from the list; and
storing the hash values of the identifiers of the malicious hosts in the Bloom filter.

6. The method of claim 5, further comprising:
receiving an updated list;
identifying one or more identifiers in the list that are not included in the updated list; and
removing, from the Bloom filter, hash values generated from the one or more identifiers not included in the updated list.

7. The method of claim 1, wherein monitoring the plurality of transmissions includes monitoring the plurality of transmissions via a network security device that is a peer to the device.

8. The method of claim 1, wherein monitoring the plurality of transmissions includes monitoring the plurality of transmissions via either a firewall or a switch.

9. The method of claim 1, wherein identifying the request includes identifying a request that includes at least one of a host name and a transmission control protocol/Internet protocol address.

10. The method of claim 1, wherein determining whether the identifier is stored within the list includes searching a structured query language table.

11. The method of claim 1, wherein monitoring the plurality of transmissions includes monitoring a plurality of transmissions within an internal network disposed behind a firewall.

12. A network monitor system comprising:
memory;
a network interface; and
at least one processor coupled to the memory and the network interface and configured to:
monitor a plurality of transmissions within an internal network via the network interface;
identify, within a transmission of the plurality of transmissions, a request from a device to communicate with a third party host, the request including an identifier of the third party host;
generate a hash value based on the identifier;
determine whether the hash value is stored within a Bloom filter generated from hash values of identifiers of malicious hosts;
responsive to the determination that the hash value is stored within the Bloom filter, determine whether the identifier is stored within a list of the identifiers of the malicious hosts; and
responsive to the determination that the identifier is stored within the list, disrupt subsequent transmissions between the device and the third party host; and
a pre-cognition detection engine in communication with the at least one processor, the pre-cognition detection engine comprising a Bloom Filter and an SQL table,
wherein at least one of the Bloom Filter and the SQL table is used to determine whether a requested third party host name is associated with a known malicious host.

13. The network monitor system of claim 12, further comprising a web server.

14. The network monitor system of claim 12, wherein the processor is further configured to disrupt subsequent transmissions from a process being executed by the device without disrupting other operations of the device.

15. The network monitor system of claim 12, wherein the processor is further configured to disrupt connectivity between the device and the internal network.

16. The network monitor system of claim 12, the processor further configured to permit the subsequent transmissions in response either to determining that the identifier is not stored in the list or to determining that the hash value is not stored within the Bloom filter.

17. The network monitor system of claim 12, wherein the processor is further configured to:
receive the list;
generate the hash values of the identifiers of the malicious hosts from the list; and
cause the hash values of the identifiers of the malicious hosts to be stored in the Bloom filter.

18. The network monitor system of claim 12, wherein the network monitor system is a peer to the device.

19. The network monitor system of claim 12, further comprising at least one of a firewall and a switch in communication with the network monitor system.

20. The network monitor system of claim 12, wherein the processor is configured to monitor a plurality of transmissions within an internal network disposed behind a firewall.
